(19) United States
(12) Patent Application Publication
(10) Pub. No.: US 2012/0258659 A1
(43) Pub. Date: Oct. 11, 2012

(54) System and Method for Remotely Distributing Firmware Upgrades to Large Numbers of Distributed Devices

(76) Inventors: Stephen P. Emmons, Carrollton, TX (US); Jeffrey O. Smith, Dallas, TX (US)

(21) Appl. No.: 13/440,347

(22) Filed: Apr. 5, 2012

Related U.S. Application Data
(60) Provisional application No. 61/471,935, filed on Apr. 5, 2011.

(51) Int. Cl. H04W 4/00

(52) U.S. Cl. 455/12.1; 455/517

(57) ABSTRACT

A system for sending updates to a large number of remote units is described. The system includes a plurality of remote units, each remote unit comprising one or more sensors and a communications transceiver. A control center is in communication with the remote units and includes an update database reflecting the update status of each of the plurality of remote units. The control center establishes contact with each of the plurality of remote units and sends an update when communication has been established. The update database is periodically updated to reflect the completion of the update for each mobile unit based on a completion message from each of the remote units that has successfully installed the update.

### CROSS REFERENCE TO RELATED INFORMATION

This application claims the benefit of U.S. Provisional Patent Application Ser. No. 61/471,935, filed Apr. 5, 2011.

### TECHNICAL FIELD

The present disclosure is directed to machine-to-machine communications and monitoring, and more particularly to sending programming updates to a large number of distributed devices.

### BACKGROUND OF THE INVENTION

Many companies use large numbers of mobile assets such as vehicles, shipping containers, barges, commercial equipment, palettes, and other similar objects in their everyday business. Other companies and industries use remote sensors to collect data that is used in their businesses. More and more companies are turning to remote asset tags, sensors and tracking devices to obtain access to remotely collected data, continuous location and status updates on those mobile objects and sensors. These remote devices use a wide range of existing satellite, cellular and other tracking services to keep tabs on the mobile or remote objects. In many instances, those remote devices also use cellular, wireless networking, or even satellite communications to report their location, data and/or status to a monitoring center.

From time to time, programming updates need to be installed on each of the remote or mobile units. As each of the units is often, or always, out in the field and away from the control center, it is very expensive and complicated to recall each of the units or to send a technician to find each unit to install each firmware update. Instead it would be preferable to send programming updates over the communications networks being used by the units to report their status and location. Such a system, however, would need to be able to confirm that the update was received and installed by each mobile unit.

What is needed is a system that can monitor communication and communication patterns of mobile objects/units and to act when those units approach a usage threshold.

### BRIEF SUMMARY OF THE INVENTION

An embodiment of a system for sending updates to a large number of remote or mobile units is described. The system includes a plurality of remote units, each remote unit comprising one or more sensors and a communications transceiver. A control center, that includes an update database reflecting the update status of each of the plurality of remote units, establishes contact with each of the plurality of remote units and sends an update when communication has been established. The update database is updated to reflect the completion of the update for each mobile unit based on a completion message from each of the plurality of remote units.

In another embodiment, a method for sending updates to a large number of remote or mobile units is described. The method includes receiving at a control center an update for one or more of a plurality of remote units, generating a list of the one or more of the plurality of remote units that require the update, and contacting each of the remote units requiring the update. The method further includes sending the update to each remote unit on the list once contact with the remote unit has been established, and confirming completion of installation of the update at each of the remote units on the list by receiving a status update from the remote unit. The method checks the list for remote units that have not confirmed completion of the update and re-contacts those remote units that have not confirmed completion of the update.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an embodiment of a system for distributing firmware updates to a large number of multiple mobile units;

FIG. 2 is a block diagram of an embodiment of an asset tag for a mobile unit having wireless communications capabilities; and

FIG. 3 is a flow chart for an embodiment of a method of distributing firmware updates to a large number of multiple mobile units.

### DETAILED DESCRIPTION OF THE INVENTION

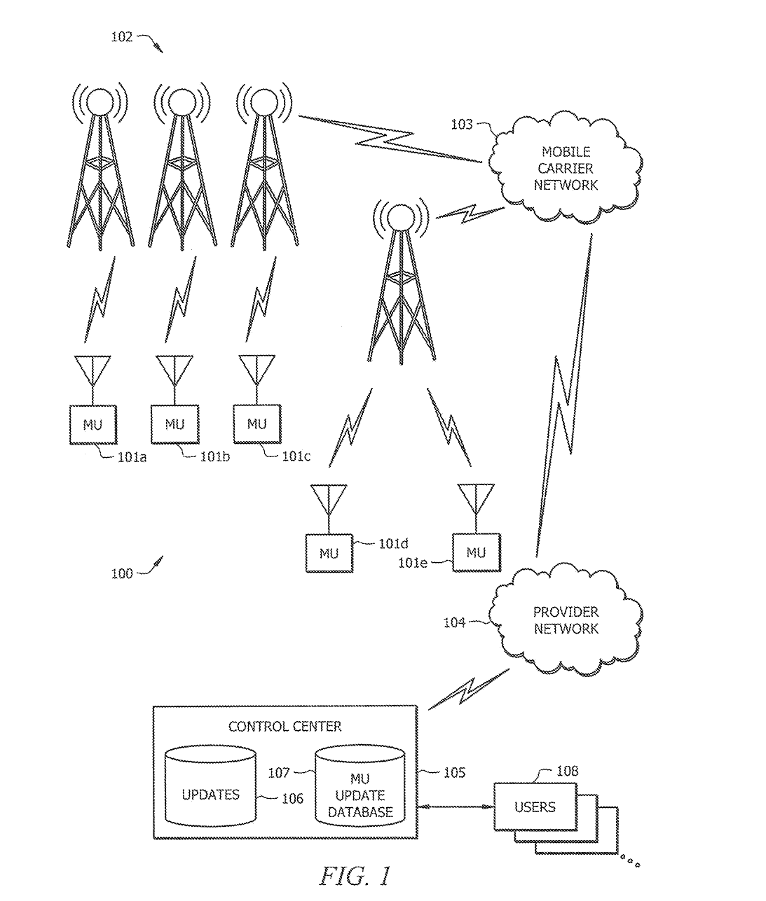

Referring now to FIG. 1, the present invention describes an embodiment of a system 100 for monitoring the communications of a large number of remote or mobile units 101a through 101e that are programmed to report location, data and/or status periodically, in response to an event, or in response to a request by a monitoring center. The mobile units use cellular or satellite (not shown) networks to send data to a control or monitoring center 105 which collects the location and/or status data for each of the mobile units 101a through 101e. While a cellular network having cell stations 102 and carrier network 103 are shown communicating with a provider network 104 connected to control center 105, any type or combination of communications network can be used without departing from the scope of the concepts described herein. Other examples of communications networks may include satellite, wireless networking, radio frequency or any other network with the requisite functionality.

When programming, software, firmware, configuration or similar updates are available for the mobile units, the control center 105 collects those firmware updates and the identity of the mobile units requiring those updates and stores that information. Separate databases may be employed for the updates 106 and the mobile unit update status 107, or the databases may be combined. Users 108, which can be the asset owners can access control center 105 to upload updates, check on the status of their mobile units or to retrieve location, data and reporting information related to the mobile units. The control center 105 can then attempt to contact each mobile device requiring the update or can wait until it receives a message from each mobile unit 101a through 101e. In either event, once the control center 105 establishes contact, it initializes the firmware update process and begins sending the update to each mobile unit to which contact has been established. Once a mobile unit receives the entire update and has installed it, it preferably sends a confirmation to the control center which is then noted in the MU update database 107. If the confirmation is not received, for instance because communication link was broken and the entire update was not received, the control center tries to re-contact each non-updated mobile unit and each mobile unit to which the control center has not yet made contact.

For each mobile unit that has received and confirmed the update, the MU update database 107 is updated to reflect that the mobile unit is up to date. The control center 105 continues this process until each of the mobile units 101a through 101e has confirmed the installation of the updated software. The owners/users/operators 108 of each mobile unit can be sent reports reflecting the status of the software update process. While a particular number of mobile units are represented in FIG. 1, any number of mobile units can be accommodated using the concepts described herein.

The system preferably uses the data channels of cellular networks 103 to communicate and send the software updates, but can use any wireless communications technology available to the mobile unit, including satellite and wireless networking technologies. In addition, the protocols used in preferred embodiments of the system are agnostic to technical details of the specific devices and can be used across a spectrum of devices and technologies.

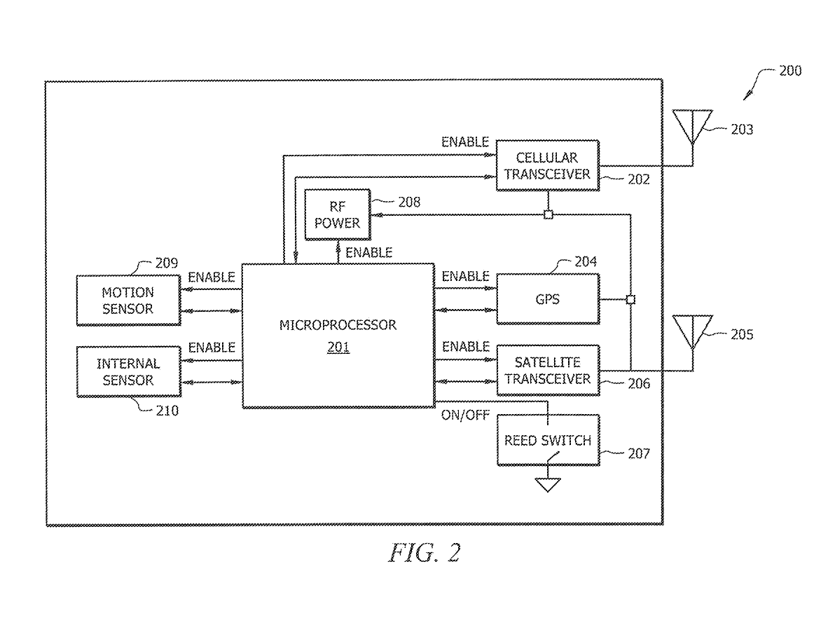

Referring now to FIG. 2, an embodiment of a remote sensor or mobile asset tag that can be used with each remote or mobile unit is described. The unit, or tag, 200 includes a microprocessor 201 programmable to execute desired instructions and to control the operation of tag 200. The processor 201 may have internal memory capable of storing data and programming information or may use memory external to the microprocessor. The tag 200 also includes a cellular transceiver 202 and associated cellular antenna 203 to perform cellular communications. Power for the cellular transceiver is supplied by RF power module 208. The tag 200 also includes a satellite location determination device 204, which can be GPS or satellite service based, and a satellite transmitter, receiver or transceiver 206, which uses satellite antenna 205.

As described, communications with the control center can be done using satellite, cellular or other long range communication systems. Sensors 209, 210 can be embedded in or connected to the device to collect data, detect motion, detect the presence of another object, or any other type of data or environmental information: Such information can be collected and reported to the data center or can also be used to trigger actions by the mobile device. Reed switch 207 is an electrical switch that is activated by a magnetic field and can be used to enable or disable the device. While unit 200 is shown with a particular combination of sensors and communication elements, the specific configuration of each device can vary according to its intended use and may include a particular sensor or array of sensor, may include one communications system or multiple communications systems, and may include any of a variety of location determination modules or none at all.

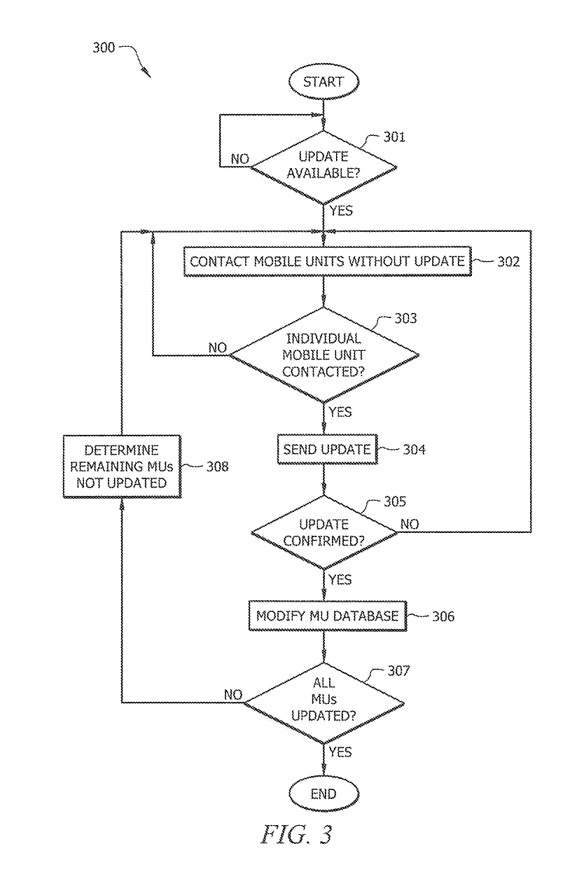

Referring now to FIG. 3, a flow chart of an embodiment of a method 300 for updating the software, firmware programming, configuration, or similar updates for remote devices/mobile units is described. The method begins in decision block 301 by detecting an available update for one or more of a plurality of mobile units, each of the mobile units geographically distributed from the control center. The control center then attempts to contact each mobile unit, as shown by block 302, or waits to be contacted by each mobile unit. Particular mobile units may be initially unavailable to the control center by being out of range or unable to establish a good communications link. Decision block 303 determines whether individual units have contacted the control center. If a unit has not contacted the control center the method can either wait or return to block 302 where the control center re-contacts the mobile unit.

Once a particular mobile unit has been contacted, the control center sends the update to that mobile unit to be installed by the mobile unit, as shown by block 304. Once finished, the mobile unit confirms completion as shown by block 305 of the installation and returns to normal operation. If the update is not confirmed by the mobile unit having been installed, the method returns to block 302 to re-attempt the update. The update may fail for a variety of reasons, including loss of communications contact with the control center, or interruption due to events at the mobile unit. Once the update has been confirmed at that mobile unit, the MU update database at the control center is updated to reflect the completion of the update for that mobile unit, as shown by block 306.

The control center periodically checks to see if all the mobile units required to install the update has been complete, as shown by block 307, and if not, determines the remaining mobile units to be updated, block 308, and attempts to contact those mobile units to complete the update process. While method 300 illustrates a preferred embodiment of the update process according to the concepts described herein, one skilled in the art would recognize that variations on the process can be implemented without departing from the scope of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for sending updates to a large number of remote units, the system comprising:
a plurality of remote units, each remote unit comprising one or more sensors and a communications transceiver; and
a control center, the control center including an update database reflecting the update status of each of the plurality of remote units, wherein the control center establishes contact with each of the plurality of remote units and sends an update when communication has been established, and wherein the update database is updated to reflect the completion of the update for each mobile unit based on a completion message from each of the plurality of remote units.

2. The system of claim 1 wherein the update is one or more of a programming, software, firmware, and configuration update.

3. The system of claim 1 wherein one or more of the plurality of remote units includes location detection functionality.

4. The system of claim 1 wherein the communications transceiver is a cellular transceiver.

5. The system of claim 1 wherein the communications transceiver is a satellite transceiver.

6. The system of claim 1 wherein the communications transceiver is a wireless networking transceiver.

7. The system of claim 1 wherein one or more of the remote units are mobile asset tags.

8. The system of claim 1 wherein one or more of the remote units are remote sensors.

9. The system of claim 1 wherein the control center periodically attempts to establish contact with each remote unit that has not sent the completion message indicating that it has completed the update, as reflected in the update database.

10. The system of claim 1 wherein the control center is accessible by operators of the plurality of remote units to allow the operators to check on the status of the remote units.

11. A method for sending updates to a large number of remote units, the method comprising:
receiving at a control center an update for one or more of a plurality of remote units;
generating a list of the one or more of the plurality of remote units that require the update;
contacting each of the remote units requiring the update;
sending the update to each remote units on the list once contact with the remote unit has been established;
confirming completion of installation of the update at each of the remote units on the list by receiving a status update from the remote unit;
checking the list for remote units that have not confirmed completion of the update; and
re-contacting those remote units that have not confirmed completion of the update.

12. The method of claim 11 wherein the update is one or more of a programming, software, firmware, and configuration update.

13. The method of claim 11 wherein each remote unit comprises one or more sensors, a communications transceiver, and location detection functionality.

14. The method of claim 13 wherein the communications transceiver is a cellular transceiver.

15. The method of claim 13 wherein the communications transceiver is a satellite transceiver.

16. The method of claim 13 wherein the communications transceiver is a wireless networking transceiver.

17. The method of claim 11 wherein one or more of the remote units are mobile asset tags.

18. The method of claim 11 wherein one or more of the remote units are remote sensors.

19. The method of claim 11 further comprising resending the update to each remote unit that has not sent the completion message indicating that it has completed the update, as reflected in the list.

20. The method of claim 11 wherein the control center is accessible by operators of the plurality of remote units to allow the operators to check on the status of the remote units.
